(19) United States
(12) Patent Application Publication
(10) Pub. No.: US 2026/0342055 A1
(43) Pub. Date: Oct. 29, 2026

(54) SYSTEMS FOR HOUSING ADVANCED METERING INFRASTRUCTURE EQUIPMENT

(71) Applicant: Florida Power & Light Company, Juno Beach, FL (US)

(72) Inventors: Gary W. Sterkel, Plantation, FL (US); Luis Garcia, Pembroke Pines, FL (US)

(21) Appl. No.: 19/187,531

(22) Filed: Apr. 23, 2025

(51) Int. Cl. H02B 1/32; H02B 1/30; H02B 1/38

(52) U.S. Cl. CPC H02B 1/32; H02B 1/305; H02B 1/38

(57) ABSTRACT

The disclosed technology relates generally to systems for housing AMI equipment. The disclosed technology includes a system for housing AMI equipment. The system includes an enclosure. The system further includes a door hingedly connected to the enclosure. The system further includes a first mount configured to secure an AMI device within an interior of the enclosure. The system can further include a solar mount assembly configured to secure a solar power assembly to the enclosure, the solar power assembly configured to provide power to the AMI device.

### FIELD OF TECHNOLOGY

The disclosed technology relates generally to enclosures for electrical equipment, and, more particularly, to systems for housing advanced metering infrastructure equipment.

### BACKGROUND

Advanced Metering Infrastructure (AMI) systems are integral components of modern utility networks, enabling the automated collection, measurement, and analysis of energy consumption data. These systems enhance the efficiency and reliability of utility services by providing real-time data, facilitating demand response, and improving outage management.

Traditionally, AMI equipment is housed in above-ground enclosures, which are susceptible to environmental factors such as weather conditions, physical damage, and unauthorized access. These vulnerabilities can lead to equipment malfunctions, data inaccuracies, and increased maintenance costs. Additionally, above-ground installations often face aesthetic concerns and space constraints in urban environments.

What is needed, therefore, is a novel system for housing AMI equipment. These and other advantages of the presently-disclosed technology will become apparent throughout the following disclosure.

### BRIEF SUMMARY

According to an aspect of the present disclosure, the disclosed technology includes a system for housing AMI equipment. The system can include an enclosure. The system can include a door hingedly connected to the enclosure. The system can include a first mount configured to secure an AMI device within an interior of the enclosure.

According to another aspect of the present disclosure, the disclosed technology includes a system for housing AMI equipment. The system can include an enclosure. The enclosure can be configured to be installed, at least partially, below a ground line. The system can include a door hingedly connected to the enclosure. The system can include a first mount configured to secure an AMI device within an interior of the enclosure. The system can include a second mount configured to secure a solar controller unit within the interior of the enclosure. The system can include a solar mount assembly configured to secure a solar power assembly to an exterior of the enclosure. The system can include a battery mount configured to secure a battery within the interior of the enclosure.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device or system embodiments, it is to be understood that such exemplary embodiments can be implemented in various devices, systems, and methods of the present disclosure.

### BRIEF DESCRIPTION OF THE DRAWINGS

The accompanying drawings, which are incorporated in and constitute a part of this specification, illustrate various aspects of the presently disclosed subject matter and serve to explain the principles of the presently disclosed subject matter. The drawings are not intended to limit the scope of the presently disclosed subject matter in any manner.

FIG. 1 illustrates a perspective view of an enclosure of a system for housing AMI equipment, in accordance with examples of the present disclosure.

FIG. 2 illustrates an interior of an enclosure of a system for housing AMI equipment, in accordance with examples of the present disclosure.

FIG. 3 illustrates a sectional view of an enclosure of a system for housing AMI equipment, in accordance with examples of the present disclosure.

FIG. 4 illustrates a rear view of an enclosure of a system for housing AMI equipment, in accordance with examples of the present disclosure.

FIG. 5 illustrates an isometric view of a top of an enclosure of a system for housing AMI equipment including one or more exterior mounts, in accordance with examples of the present disclosure.

FIG. 6 illustrates a side view of a system for housing AMI equipment including an antenna mount assembly, in accordance with examples of the present disclosure.

FIG. 7 illustrates a side view of a system for housing AMI equipment including a solar mast, in accordance with examples of the present disclosure.

FIG. 8A illustrates a top view of a system for housing AMI equipment, in accordance with examples of the present disclosure.

FIG. 8B illustrates a bottom view of a system for housing AMI equipment, in accordance with examples of the present disclosure.

FIGS. 9A-9C illustrate a first mount of a system for housing AMI equipment, in accordance with examples of the present disclosure.

FIGS. 10A-10B illustrate a front view and a rear view of a system for housing AMI equipment including an antenna, in accordance with examples of the present disclosure.

FIG. 11 illustrates a view of an interior of an enclosure of a system for housing AMI equipment including an antenna, in accordance with examples of the present disclosure.

FIGS. 12A-12B illustrate a system for housing AMI equipment including a solar power assembly, in accordance with examples of the present disclosure.

FIG. 13A illustrates a system for housing AMI equipment including a pad mount transformer, in accordance with examples of the present disclosure.

FIG. 13B illustrates a system for housing AMI equipment including a pad mount transformer, in accordance with examples of the present disclosure.

FIG. 14 illustrates a block diagram of a system for housing AMI equipment, in accordance with examples of the present disclosure.

### DETAILED DESCRIPTION

To address the previously discussed challenges, there is a growing need for innovative solutions that provide secure, reliable, and unobtrusive housing for AMI equipment. One such solution involves the use of enclosures that can be installed, at least partially, below the ground line. This approach offers several advantages, including enhanced protection from environmental factors, reduced risk of physical damage, and improved security against unauthorized access.

Moreover, the integration of renewable energy sources, such as solar power, into AMI systems is becoming increasingly important. Solar-powered AMI systems can operate independently of the grid, ensuring continuous data collection and transmission even during power outages. This requires the development of specialized enclosures that can accommodate solar power assemblies and associated components, such as solar controllers and batteries.

Additionally, installing mounts within and on the exterior of traditional enclosures can be labor intensive. Further, many typical enclosures are not currently equipped to house equipment to allow the enclosure to be powered via a primary source and a secondary source, much less enable transition between the two.

The disclosed technology relates generally to systems for housing AMI equipment. Unlike existing systems that are susceptible to weather, power outages, remote installation, and require on-site mount installation, the disclosed technology employs a novel system and enclosure for housing AMI equipment that can be weather resistant, easy to maintain, and simple to install. The disclosed technology provides a system for a “total solution” for supporting installation of AC powered cellular or radio communication, or stand-alone solar powered cellular or radio communication in underground areas (areas lacking poles). Custom mounting solutions can be included to support quick installation and/or maintenance of required components for the AC powered and solar powered solutions. The inclusion of custom mounting can reduce installation and maintenance time. The system can further provide a hardened enclosure to withstand environmental conditions and protect installed cellular and radio components, as will be appreciated herein.

The disclosed technology can include a system for housing AMI equipment. The system, according to some embodiments of the disclosed technology, can include an enclosure, the enclosure configured to house AMI equipment. The enclosure can have a door configured to open and close to cover and uncover an opening of the enclosure, such that the components of the system disposed within the enclosure can be accessed via the opening. The door can be connected to the enclosure via hinges, as can be appreciated, and can interface with a water-exclusion tray when closed to prevent water, such as rain or other elements, from entering the opening and damaging equipment. The door can further include locks for securing the system. Additionally, the enclosure can include side walls, a top, and a bottom, with a lip towards the bottom of the enclosure. The lip can not only aid in securing the enclosure when installed but can also include mounts for components of the system designed to be mounted on the exterior of the enclosure. The system can include an AMI device to be secured within the interior of the enclosure, along with a backup battery for the AMI device. The interior of the enclosure can include mounts integral with the interior walls of the enclosure, allowing for simple installation and maintenance. Said mounts can include a bracket mount for the AMI device, battery mount, a solar controller mount, and a shelf for another type of battery. The enclosure can further include apertures extending through the side walls, which can be part of the interior mounts and/or can allow electrical connection between components of the system secured within the interior of the enclosure and components located externally to the enclosure. Said apertures can include water-tight grommets to further protect the interior from water intrusion. Accordingly, the enclosure can include mounts disposed on an exterior of the enclosure. Components of the system mounted on the exterior of the enclosure can include one or more antennas, a solar power assembly including a solar panel and a mast for securing the panel to the enclosure, and the like. That is, the exterior of the enclosure can include mounts integral to the exterior of the enclosure that can secure one or more antennas. In combination with the one or more antennas, the AMI device can, in some cases, transmit and receive wireless communications via a network connection. For example, the AMI device can be a radio configured to transmit and receive radio communications using the one or more antennas.

Systems of the disclosed technology can include multiple configurations. In some cases, the system can be configured for AC power, in that the AMI device disposed within the enclosure can be powered via an AC power source external to the enclosure. As understood in the art, said external power source can be a pad mount transformer, from which the AMI device can be electrically connected to via an underground conduit between the enclosure and the pad mount transformer. In case of loss of power from the pad mount transformer, the system can include a backup AC battery secured within the enclosure to provide backup power for the AMI device. In some cases, the system can be further configured to operate using solar power. As will be discussed in greater detail herein, in some embodiments the system can be configured to operate in a stand-alone manner, being powered solely from solar power of a solar power assembly mounted to the system. The system can further include a solar backup battery to provide auxiliary power in the event of low power output from the solar power assembly. Accordingly, a solar panel can be mounted to the exterior of the enclosure via one or more solar mounts disposed on the exterior. The solar power from the solar panel, as part of the solar power assembly, can be monitored and regulated via a solar controller disposed within the interior of the enclosure. Similar to other interior components, the solar controller can be secured via a mount integral with an interior wall of the enclosure. Additionally, a solar backup battery can be stored within the enclosure on a shelf, allowing the AMI device to continue to operate in the event of low solar charge, inclement weather, or other conditions affecting the viability of solar power. With the AC power and solar power configurations, embodiments of systems of the disclosed technology can be configured to power the AMI device using externally produced AC power, solar power, or switch between said power sources. In this way, systems of the disclosed technology present a novel system for housing AMI devices, such as radios, allowing self-sustaining power via solar solutions, while still enabling traditional power methods of AC power.

Although various aspects of the disclosed technology are explained in detail herein, it is to be understood that other aspects of the disclosed technology are contemplated. Accordingly, it is not intended that the disclosed technology is limited in its scope to the details of construction and arrangement of components expressly set forth in the following description or illustrated in the drawings. The disclosed technology can be implemented and practiced or carried out in various ways. In particular, the presently disclosed subject matter is described in the context of systems for housing AMI equipment. The present disclosure, however, is not so limited, and can be applicable in other contexts such as systems used for housing AMI equipment for other purposes such as academic and industrial purposes. Accordingly, when the present disclosure is described in the context of systems of housing AMI equipment, it will be understood that other implementations can take the place of those referred to herein.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the disclosed technology can include from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

The components described hereinafter as making up various elements of the disclosed technology are intended to be illustrative and not restrictive. Many suitable components that would perform the same or similar functions as the components described herein are intended to be embraced within the scope of the disclosed technology. Such other components not described herein can include, but are not limited to, similar components that are developed after development of the presently disclosed subject matter.

As used herein, the terms “advanced metering infrastructure” and “advanced metering infrastructure equipment” can include any system or device configured to facilitate an advanced metering process, which as understood by those skilled in the art, can include a two-way communication between utilities and customers characterized by automated collection, analysis, and management of energy use data. Advanced metering infrastructure (sometimes referred to herein as “AMI”) can support real-time monitoring, dynamic pricing, and improved outage management. As non-limiting examples, AMI can include smart meters, communication networks, data management systems, home area networks, meter data management systems, gateways, repeaters, outage management systems, load control devices, radio equipment, etc.

Referring now to the drawings, in which like numerals represent like elements, the present disclosure is herein described.

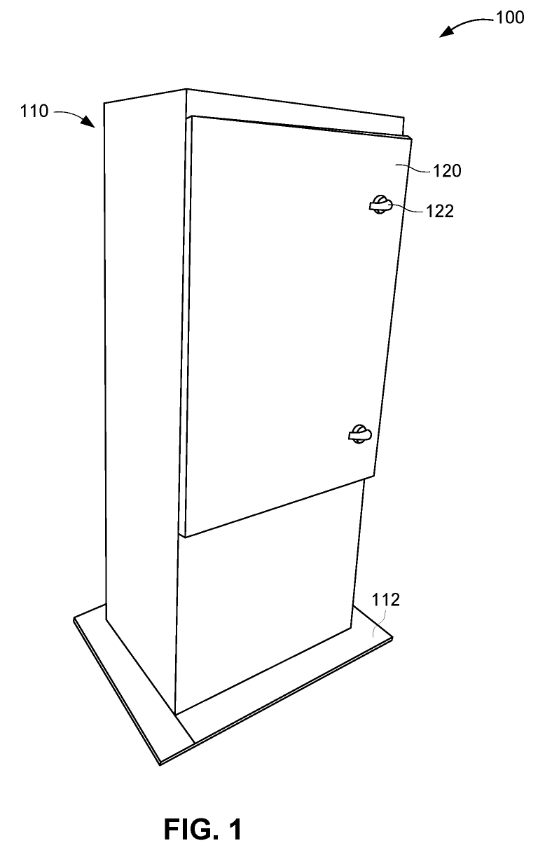

FIG. 1 illustrates a system 100 for housing AMI equipment. As will become apparent throughout this disclosure, the system 100 (as well as other examples described herein) can be used for installing, securing, and housing equipment used for advanced metering of utilities.

The system 100 can include enclosure 110 having a door 120. The enclosure 110 can include a generally box shape with side walls, a top side, a bottom side, and a lip 112 extending outwardly from the side walls proximate the bottom side of the enclosure 110. As can be appreciated, the lip 112 can provide stability for the enclosure 110 when installed, as the lip 112 can be disposed below a ground line when the enclosure 110 is installed. Additionally, the lip 112 can include one or more mounts for exterior components of the enclosure 110, as will be discussed in greater detail herein.

The enclosure 110 can include an aluminum material to prevent rusting over extended periods of use. In some embodiments, the enclosure 110 and the door 120 can be substantially made out of aluminum. In other embodiments, the enclosure 110 and the door 120 can include any material understood by those skilled in the art for enclosures of similar contexts. For example, the enclosure 110 and the door 120 can include a metal material (e.g., steel, etc.) or a fibrous material (e.g., fiberglass, carbon fiber, etc.). Further, the enclosure 110 and the door 120 can be coated to improve material strength of the enclosure 110 and the door 120 and/or to reflect heat. For example, the enclosure 110 can be powder coated to reflect UV radiation and reduce heat. Reflecting heat can provide a number of benefits for the system 100; for example, heat reflection can prevent degradation of the enclosure 110 and the door 120 while insulating interior components of the enclosure 110 from extreme temperatures. In some embodiments, the enclosure 110 and the door 120 can be coated with a high-impact coating for at least these reasons. As can be appreciated, the coating may include coloring to blend the enclosure 110 and the door 120 with surroundings of an installation site or other electrical housings disposed near the installation site for the system 100.

As will be appreciated, the door 120 can be hingedly connected to the enclosure 110. As shown in FIG. 1, the door 120 can have a closed position, such that the door 120 can cover an opening of the enclosure 110 when in the closed position. The door 120 can include one or more locking mechanisms 122 configured to secure the door 120 in the closed position. In other words, the one or more locking mechanisms 122 can prevent the door 120 from swinging open due to gravity, wind, etc., which can further improve weather-resistance of the system 100. In some embodiments, the one or more locking mechanisms 122 can include a key, digital lock, or the like to prevent unauthorized access of an interior of the enclosure 110.

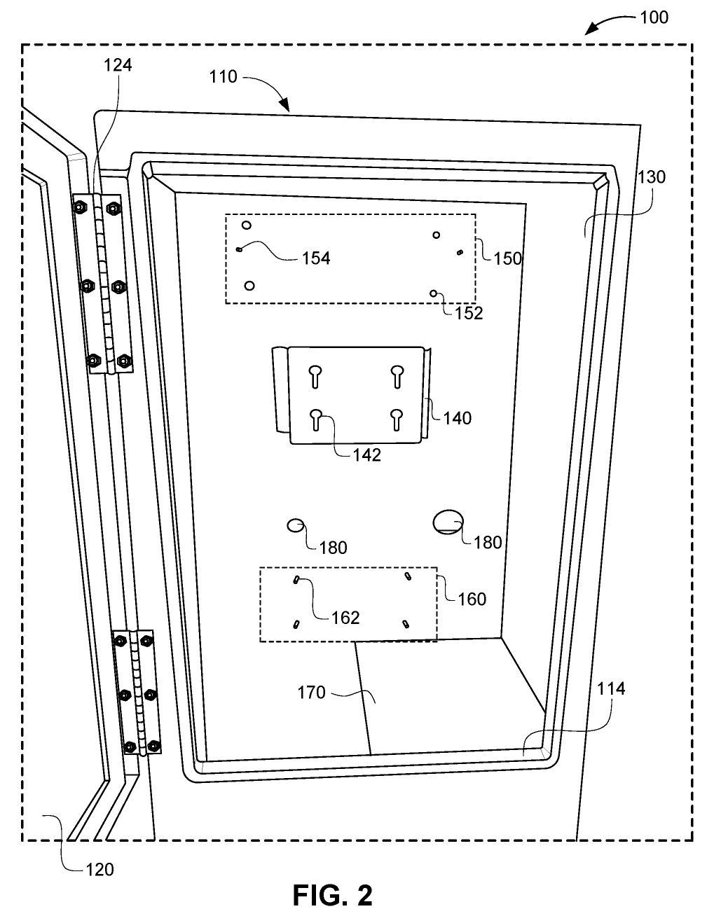

FIG. 2 illustrates the system 100 including the enclosure 110 having the door 120 hingedly connected and in an open position. As shown, the door 120 being in the open position can expose the opening of the enclosure 110 and an interior 130 of the enclosure 110. The opening can be disposed on a side wall of the enclosure 110 so that interior components of the enclosure 110 can be easily and safely accessible by installation or maintenance personnel. The system 100 can include a hinge 124 connected to the enclosure 110 and the door 120, configuring the door 120 to be opened and closed. Stated otherwise, the door 120 can be hingedly connected to the enclosure 110 via the hinge 124, such that the door 120 can transition between the open position and a closed position. Additionally, the enclosure 110 can include a water exclusion tray 114 configured to prevent water from intruding into the interior 130 of the enclosure 110. The water exclusion tray 114 can be an outer flange disposed about the opening to the enclosure 110 extending away from a center of the opening. The outer flange can be shaped so that when the door 120 is in the closed position, even if water intrudes through a gap between the door 120 and a side wall of the enclosure 110, the outer flange of the water exclusion tray 114 can block the water from travelling to the interior 130 and can redirect the water to travel away from the opening to the enclosure 110.

As shown, the interior 130 of the enclosure 110 can include interior mounts configured to house electrical equipment, such as AMI equipment. As will be appreciated, the interior mounts, and in some cases exterior mounts of the enclosure 110, can be installed or fabricated on the enclosure 110 during a manufacturing process of the enclosure 110 rather than in the field. Stated otherwise, any embodiments of mounts disposed within the interior 130 of the enclosure 110 can be integral to the enclosure 110, which can reduce labor time and costs needed for install of the system 100.

Accordingly, the system 100 can include a first mount 140 configured to secure an AMI device. The first mount 140 can be disposed within the interior 130 of the enclosure 110, in that the first mount 140 can be configured to secure the AMI device within the interior 130 of the enclosure 110. The first mount 140 can be disposed on an interior wall of the enclosure 110 and, in some embodiments, can be disposed on a wall opposing the opening of the enclosure 110, as shown in FIG. 2. In this way, the first mount 140 can be positioned within the enclosure 110 and with respect to the opening of the enclosure 110 so as to make the first mount 140 easily accessible for installation and maintenance personnel, improving the safety of mounting and dismounting electrical components within the interior 130 of the enclosure 110 compared to traditional systems. The first mount 140 can include a bracket attached to the interior wall of the enclosure 110. As will be appreciated, a portion of the bracket can protrude a distance from the interior wall to allow mounting points or mounting features of the AMI device to secure to the bracket within the interior 130 of the enclosure. In some embodiments, the first mount 140 can be separately manufactured and attached to the interior wall of the enclosure. For example, the first mount 140 can be attached to the interior wall of the enclosure 110 via welding (or a similar mechanical process understood in the art) one or more portions of the bracket to the interior wall of the enclosure 110. In other embodiments, the bracket of the first mount 140 can be fastened to the interior wall of the enclosure 110. As will be discussed in greater detail herein, the first mount 140 can include apertures 142 configured to align with mounting points of the AMI device. That is, the apertures 142 can be sized, shaped, and positioned to interface with a mounting mechanism of the AMI device and allow for mounting of the AMI device within the interior 130 of the enclosure 110. For the sake of simplicity, only one aperture of the apertures 142 is labelled.

The AMI device can include any electrical equipment, unit, or the like configured to facilitate an advanced metering infrastructure process. For example, the AMI device can include a radio device configured to receive and transmit electrical communications in the form of signals. The signals, as understood by those skilled in the art, can include wireless or wired signals, such that the AMI device can be configured to receive and transmit wireless and wired communications. In other embodiments, the AMI device can be a metering device configured to monitor utility consumption in real-time. In some embodiments, the AMI device can be configured to measure and record consumption of electricity, gas, or water in real-time. In other embodiments, the AMI device can be a communication device (e.g., a radio) configured to transmit data related to utility consumption over a network. The network can be a radio frequency (RF) network, a power line communication (PLC) network, a cellular network, etc. In some embodiments, the network can include a cellular and/or RF mesh network. In some cases, the network can be a point to point network served by dedicated fiber. As will be discussed in greater detail herein, the enclosure 110 can further include mounts for one or more antennas, such that the AMI device can be configured to transmit and receive data related to utility consumption over one or more of the networks discussed herein. Further, the AMI device can include mounting points configured to interface with and secure to the first mount 140.

The system 100 can include a second mount 150 configured to secure a solar controller unit. As will be discussed in greater detail herein, the solar controller unit can be configured to operate a solar power assembly. The second mount 150 can include a plurality of apertures 152 and a plurality of protrusions 154 configured to align with mounting points of the solar controller unit. For the sake of simplicity, only one aperture of the plurality of apertures 152 and one protrusion of the plurality of protrusions 154 are labelled. That is, the plurality of apertures 152 can be arranged and sized based on the mounting points of the solar controller unit. For example, as shown in FIG. 2, the plurality of apertures 152 can be arranged to substantially form corners of a rectangle, such that the mounting points of the solar controller unit can substantially form corners of a rectangle. In this way, the second mount 150 can be designed on the side wall of the enclosure to mirror a mounting mechanism (including the mounting points) of the solar controller unit. In some embodiments, the second mount 150 can include only the plurality of apertures 152. In other embodiments, the second mount 150 can include only the plurality of protrusions 154, as will be discussed in greater detail herein.

The plurality of apertures 152, as shown can extend through a side wall of the enclosure 110. That is, the plurality of apertures 152 can extend from the interior 130 of the enclosure 110 to the exterior of the enclosure 110. Accordingly, the plurality of apertures 152 can be drilled into the side wall of the enclosure 110. Stated otherwise, the plurality of apertures 152 can be formed by machining the enclosure 110. As can be appreciated, the enclosure 110 can be machined pre-installation, or before the enclosure 110 is installed at an installation site. For example, the plurality of apertures 152 can be pre-drilled into the enclosure 110 prior to installation of the enclosure 110. In this way, the enclosure 110 can be installed pre-configured to mount the solar controller unit within the interior 130 of the enclosure 110 via the second mount 150, an improvement over traditional enclosures for similar contexts understood in the art.

Similarly, the plurality of protrusions 154 can be disposed on the interior wall of the enclosure 110. In some embodiments, the plurality of protrusions 154 can include studs, which as understood by those skilled in the art, can be threaded (partially or fully), welded, clinching, self-clinching, flanged, headed, etc. In this way, the plurality of protrusions 154 can be selected based on the mounting mechanism and mounting points of the solar controller unit. For example, the solar controller unit can include one or more mounting points configured to interface with embodiments of the plurality of protrusions 154 discussed herein, such that a type, size, and position of protrusions (e.g., studs) selected for the second mount 150 can be based at least in part on the mounting points of the solar controller unit. The plurality of protrusions 154 can be installed pre-installation of the enclosure 110. That is, similar to the plurality of apertures 152, the plurality of protrusions 154 can be fabricated and machined to the enclosure 110 before the enclosure 110 is installed. For example, the plurality of protrusions 154 can be welded to the interior wall of the enclosure 110, so that the plurality of protrusions 154 can be integral with the interior wall of the enclosure 110. In this way, the plurality of protrusions 154 can be selected and positioned cooperatively with the plurality of apertures 152 to align with mounting points of the solar controller unit.

The system 100 can include a battery mount 160 and a shelf 170 configured to house a battery within the interior 130 of the enclosure 110. As can be appreciated, the battery mount 160 and the shelf 170 can each be configured to house the battery, such that one or more batteries can be housed within the interior 130 of the enclosure 110. Accordingly, the battery mount 160 can include a plurality of protrusions 162 disposed on the interior wall of the enclosure 110. For the sake of simplicity, only one protrusion of the plurality of protrusions 162 is labelled. The battery mount 160 can be configured to secure the battery via the plurality of protrusions 162. The plurality of protrusions 162, similar to the plurality of protrusions 154, can be sized and positioned on the interior wall of the enclosure 110 to align with mounting points of the battery. That is, the plurality of protrusions 162 can include studs, including any examples of studs discussed herein, the studs being machined onto the interior wall of the enclosure 110 and extending into the interior 130 of the enclosure 110. As a non-limiting example, as shown in FIG. 2, the plurality of studs 206 can be arranged to substantially form the corners of a rectangle, so as to align with similarly arranged mounting points of the battery.

The shelf 170 can include a surface disposed within the interior 130 of the enclosure 110 and extending between side walls of the interior of the enclosure. As shown, the shelf 170 can extend between the interior wall of the enclosure 110 including the battery mount 160, the side wall including the opening of the enclosure 110, and another side wall of the enclosure. In some embodiments, the shelf 170 can extend between each interior wall and side wall of the enclosure, substantially spanning a width and depth of the interior 130 of the enclosure 110. In other embodiments, as shown in FIG. 2, the shelf can be disposed a distance away from a side wall of the enclosure 110, such that a gap can be disposed between the shelf 170 and the side wall. As can be appreciated, the gap can allow technicians and maintenance personnel to access a portion of the interior 130 disposed below the ground line when the enclosure 110 is installed. The shelf 170, as will be discussed in greater detail herein, can be configured to support a battery, such that a battery may be simply placed on the shelf. In this way, a battery can be easily installed and uninstalled from the enclosure 110, improving efficiency of the installation process for the system 100. As will be discussed in greater detail herein, the shelf 170 can be configured to support a solar battery, in that the battery placed on the shelf 170 can be a solar battery.

The system 100 can include one or more apertures 180 configured to facilitate electrical connection between components disposed on the interior 130 of the enclosure 110 and components disposed on the exterior of the enclosure 110. That is, components of the system 100 disposed within the interior 130 of the enclosure 110 (e.g., the AMI device, the solar controller unit, and the one or more batteries) can be electrically connected to components of the system 100 disposed on the exterior of the enclosure 110 via one or more conduits passing through the one or more apertures 180. Components of the system 100 disposed on the exterior of the enclosure 110 will be discussed in greater detail herein. The one or more conduits can include cables extending through the one or more apertures 180. In some embodiments, the one or more apertures 180 can be pre-drilled, in that the one or more apertures 180 can be machined on the enclosure 110 prior to installation of the enclosure 110. As shown, the one or more apertures 180 can include multiple apertures which can vary in size depending on the conduit passing through the aperture. As will be discussed in greater detail herein, an aperture of the one or more apertures 180 can include a water-tight grommet to prevent water from intruding into the interior 130 of the enclosure 110. In some embodiments, each of the one or more apertures 180 can include a water-tight grommet, further configuring the system 100 to operate in different weather conditions and climates.

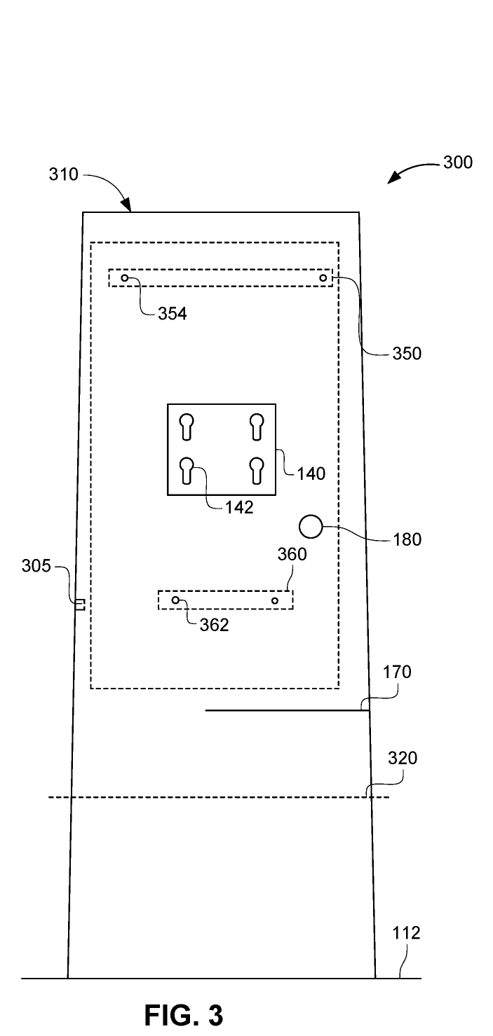

FIG. 3 illustrates a sectional view of a system 300, the sectional view showing interior mounts of an enclosure 310. The system 300 can include any embodiments of the system 100 and the enclosure 310 can include any embodiments of the enclosure 110 discussed herein. For example, the system 300 can include the first mount 140 including the apertures 142. The enclosure 310 can include the lip 112. The system 300 can include the one or more apertures 180. As shown, the one or more apertures 180, in some cases, can include a single aperture for one or more conduits to extend through. The system 300 can include a second mount 350 including any embodiments of the second mount 150 discussed herein. As shown, the second mount 350 can include a plurality of apertures 354 configured to align with mounting points of the solar controller unit. The system 300 can include a battery mount 360 including a plurality of protrusions 362 configured to secure the battery within the enclosure 310. The system 300 can include the shelf 170 configured to house a battery. Additionally, the system 300 can include a ground lug 305 disposed within the enclosure 310. The ground lug 305 can be configured to secure a ground cable within the enclosure 310 to protect technicians and maintenance personnel from electric shock.

As shown in FIG. 3, the enclosure 310 can be installed, at least partially, below a ground line 320. The enclosure 310 can be installed up to 12 inches below the ground line 320, such that the lip 112 can be disposed up to 12 inches below the ground line when the system 300 is installed. In some embodiments, the enclosure 310 can be installed up to 18 inches below the ground line 320. In some embodiments, the enclosure 310 can be installed entirely below the ground line 320. In other embodiments, the enclosures 310 can be installed entirely disposed above the ground line 320. As can be appreciated, the enclosure 310 having the lip 112 being installed partially below the ground line 320 allows for additional structural support for the enclosure 310, while still allowing accessibility of the interior components via the opening to the enclosure 310 being disposed above the ground line 320.

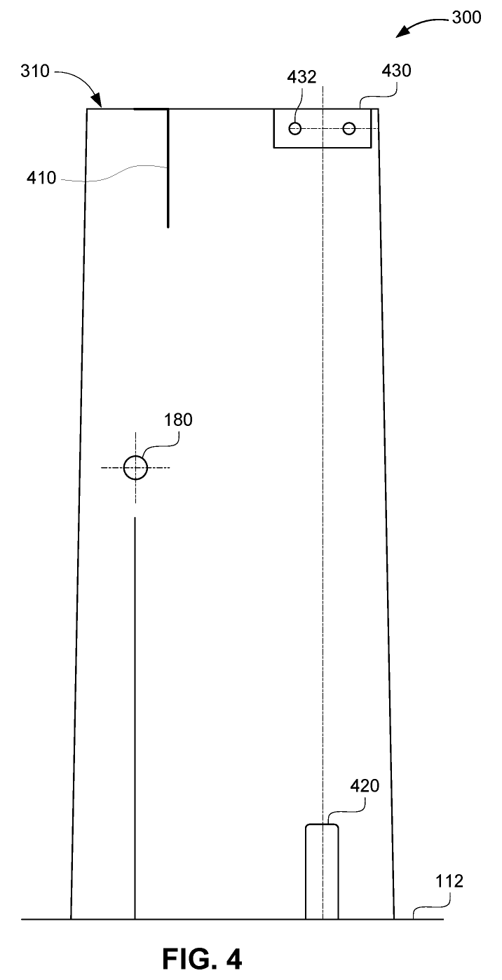

FIG. 4 illustrates a rear view of the system 300 including the enclosure 310. As shown in FIG. 4, the one or more apertures 180 can extend from the interior of the enclosure 310 to the exterior of the enclosure 310. Additionally, the system 300 can include an antenna mount assembly 410 and a solar mount assembly. The antenna mount assembly 410 can be configured to secure one or more antennas to the exterior of the enclosure 310. Stated otherwise, the antenna mount assembly 410 can include one or more antenna mounts configured to secure one or more antennas. The antenna mount assembly 410 can include a bracket attached to the exterior of the enclosure 310. In some cases, as shown, the bracket can be an angle bracket, such that a side surface of the angle bracket is attached to the enclosure 310. The antenna mount assembly 410 can be welded, or otherwise permanently attached, to the exterior of the enclosure 310. As discussed for other components of the system 300 herein, the antenna mount assembly 410 can be attached to the enclosure 310 prior to installation of the system 300.

The solar mount assembly can be configured to secure a solar power assembly to the exterior of the enclosure 310. The solar mount assembly can include a post 420 and a solar mast mount 430. The solar mast mount 430 can include one or more apertures 432. As will be discussed in greater detail herein, the post 420 and the solar mast mount 430 can be configured to secure a solar mast of the solar power assembly.

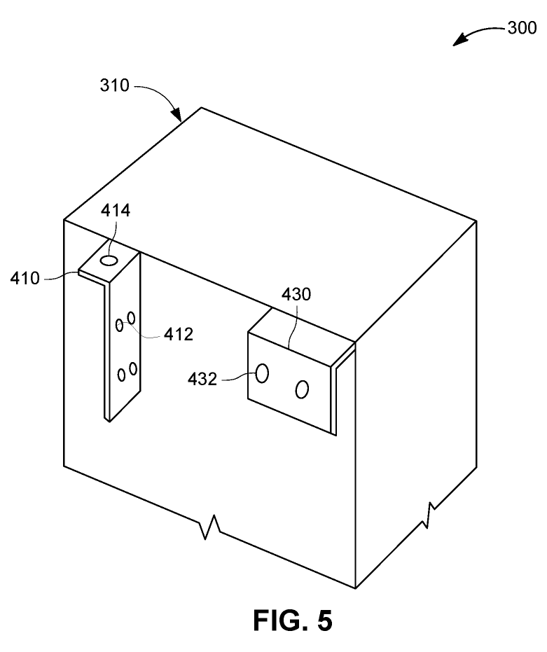

FIG. 5 illustrates an isometric view of a top portion of the system 400 including the enclosure 310, the antenna mount assembly 410, and the solar mast mount 430 of the solar mount assembly. As shown, the antenna mount assembly 410 can include a first antenna mount 412 and a second antenna mount 414. As can be appreciated, some embodiments of the antenna mount assembly 410 can include more than two mounting points, and some embodiments can include a single mounting point. The first antenna mount 412 can include apertures arranged to align with a mounting mechanism of an antenna. For example, the apertures can be arranged as shown in FIG. 5, so that an antenna can be fastened to the first antenna mount 412. As will be appreciated, the antenna can be fastened to the first antenna mount 412 via one or more U-bolts, a housing including a plurality of bolts, or the like. The second antenna mount 414 a vertically extending aperture configured to align with a mounting point of an antenna. For example, the antenna can include a protrusion (e.g., a stud, a bolt, etc.) configured to align with and be fastened to the aperture of the second antenna mount 414. In some cases, the first antenna mount 412 can be configured to secure a first antenna, and the second antenna mount 414 can be configured to secure a second antenna. Stated otherwise, the first antenna can mount to the first antenna mount 412 of the antenna mount assembly 410 and the second antenna can mount to the second antenna mount 414 of the antenna mount assembly 410. That is, the first antenna mount 412 can have a first configuration for attaching a first antenna type to the exterior of the enclosure 310, and the second antenna mount 414 can have a second configuration for attaching a second antenna type to the exterior of the enclosure. In this way, the antenna mount assembly 410 can be configured to secure multiple antennas to the exterior of the enclosure 310.

As shown in FIG. 5, the solar mast mount 430 of the solar mount assembly can extend a distance from an exterior wall of the enclosure 310. This feature can allow for a mounting mechanism for the solar power assembly, such as fastener (e.g., a U-bolt), to have space for the fastening element (e.g., a nut) to tighten about the solar mast mount 430 via the one or more apertures 432 of the solar mount assembly.

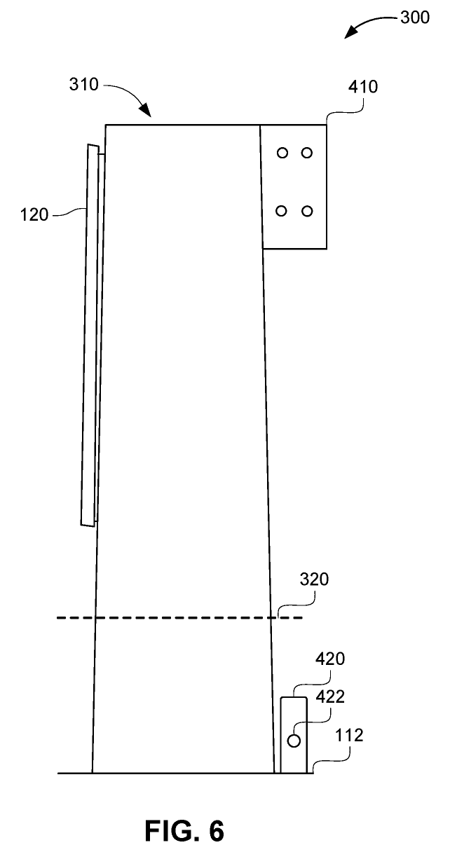

FIG. 6 illustrates a side view of the system 300 showing the enclosure 310, the door 120, the antenna mount assembly 410, and the post 420 of the solar mount assembly. As shown, the post 420 can be disposed on the lip 112 of the enclosure 310. That is, the post 420 can include a cylinder portion positioned proximate a bottom side of the enclosure and extending vertically towards an upper side of the enclosure 310. In some embodiments, the post 420 can include an aperture 422 extending through a side of the post 420, configured to receive a bolt for securing the solar mast of the solar power assembly to the post 420. In some cases, the post 420 can be disposed below the ground line 320 when the system 300 is installed, which can improve stability of the solar power assembly mounting to the enclosure 310. In other cases, the post 420 can be partially disposed below the ground line 320, so that a portion of the post 420 is above the ground line 320 when the system 300 is installed, allowing for interchangeability of the solar power assembly. For example, the aperture 422 can be disposed above the ground line 320 when the system 300 is installed, allowing a fastening bolt for the solar power assembly to removably secure the solar mast to the post 420 via the aperture 422.

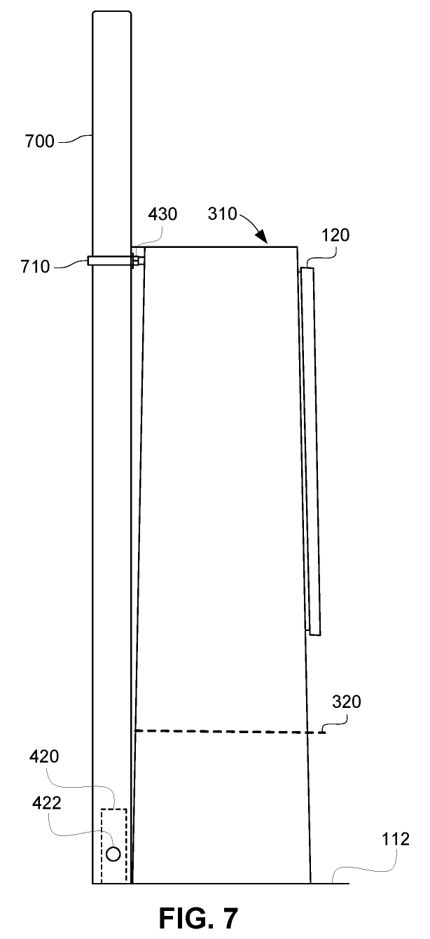

FIG. 7 illustrates a side view of the system 300 including a solar mast 700 secured to the exterior of the enclosure 310 via the post 420 and the solar mast mount 430 of the solar mount assembly. As shown, the solar mast 700 can include a partially hollow portion towards a bottom end, such that the post 420 can be disposed within the solar mast 700 when the solar mast 700 is secured to the enclosure 310. Further, the solar mast 700 can include an aperture configured to align with the aperture 422 to allow a fastening mechanism (e.g., a bolt), to pass through the aperture of the solar mast 700 and the aperture 422 to further secure the solar mast 700 to the enclosure 310. Additionally, the solar mast 700 can be secured to the solar mast mount 430 via a fastener 710 at a point disposed near the top end of the enclosure 310. The solar mast mount 430 can include a bracket integral with the exterior of the enclosure 310. In some cases, the fastener 710 can be a U-bolt configured to fasten to the solar mast mount 430 and clamp the solar mast 700 between a bolt of the U-bolt and the solar mast mount 430 of the solar mount assembly. In this way, the solar mast 700 can be secured to the enclosure 310 by the solar mount assembly at one or more points along a length of the solar mast 700.

In other embodiments, although not shown, the cylinder portion of the post 420 can include an aperture configured to receive the solar mast 700. That is, in some embodiments, at least a portion of the solar mast 700 can be configured to be inserted into the post 420. In this way, the post 420 can be configured to secure the solar mast 700 via inserting the solar mast 700, at least partially, into an aperture of the post 420.

Although not shown, the solar mast mount 430 of the solar mount assembly can be a part of multiple solar mast mounts vertically disposed on the exterior of the enclosure 310. The multiple solar mast mounts, similar to the solar mast mount 430, can each be configured to secure the solar mast of the solar power assembly. For example, each solar mast mount of the multiple solar mast mounts can be coupled with a fastener (e.g., a U-bolt) to secure the solar mast 700 to the multiple solar mast mounts. As can be appreciated, the multiple solar mast mounts can provide improved security of the solar mast 700 to the enclosure 310, which can aid performance of the system 300 in environments with extreme conditions, such as high winds. In this way, the solar mast 700 can be secured to the enclosure 310 via multiple solar mast mounts of the solar mount assembly at one or more points along a length of the solar mast 700.

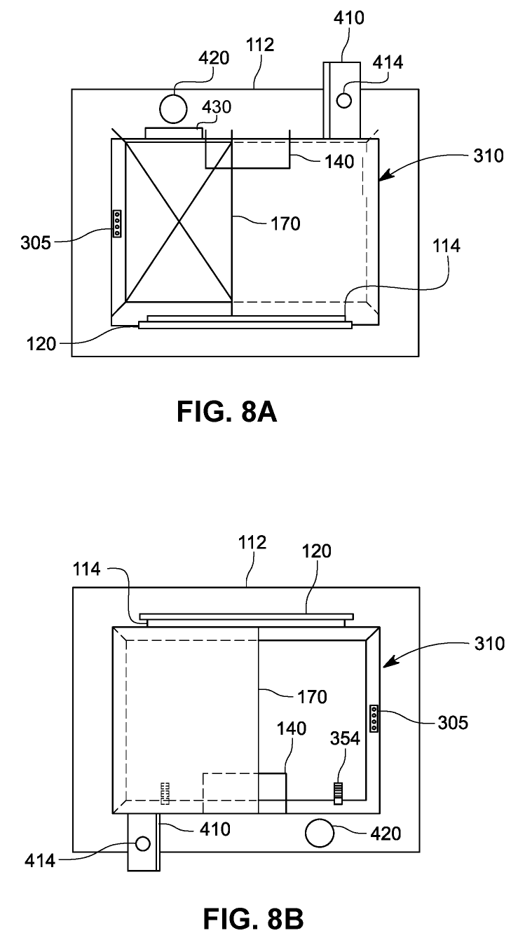

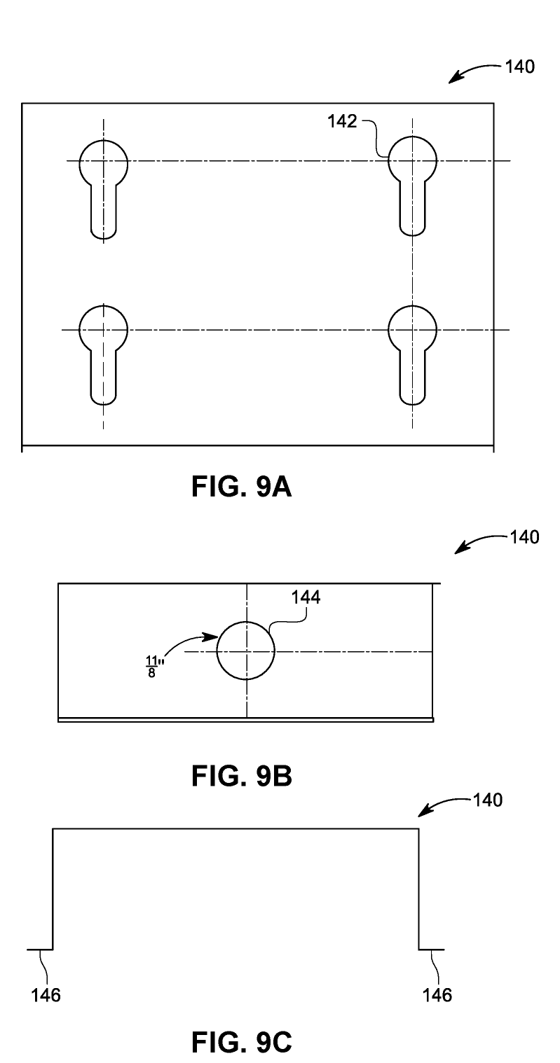

FIG. 8A illustrates a top view of the system 300 including the enclosure 310 and showing the lip 112, the water exclusion tray 114, the door 120, the first mount 140, the shelf 170, the ground lug 305, the plurality of protrusions 354, the antenna mount assembly 410, and the post 420 and the solar mast mount 430 of the solar mount assembly. As discussed herein, and as shown in FIG. 8A, the first mount 140 can protrude from an interior wall of the enclosure 310. Additionally, the post 420 can include a cylindrical portion, or stated otherwise, be substantially cylindrical. As can be appreciated, the post 420 can be vertically aligned with the solar mast mount 430 to vertically secure the solar mast of the solar power assembly.

FIG. 8B illustrates a bottom view of the system 300 including the enclosure 310 and showing the lip 112, the water exclusion tray 114, the door 120, the first mount 140, the shelf 170, the ground lug 305, the antenna mount assembly 410, and the post 420 and the solar mast mount 430 of the solar mount assembly. As shown, the plurality of protrusions 354 can be disposed on an exterior wall of the enclosure 310 and extend into the interior of the enclosure 310. In some embodiments, a protrusion of the plurality of protrusions 362 can include a threaded portion, based on the mounting mechanism of the one or more mounting points of the battery.

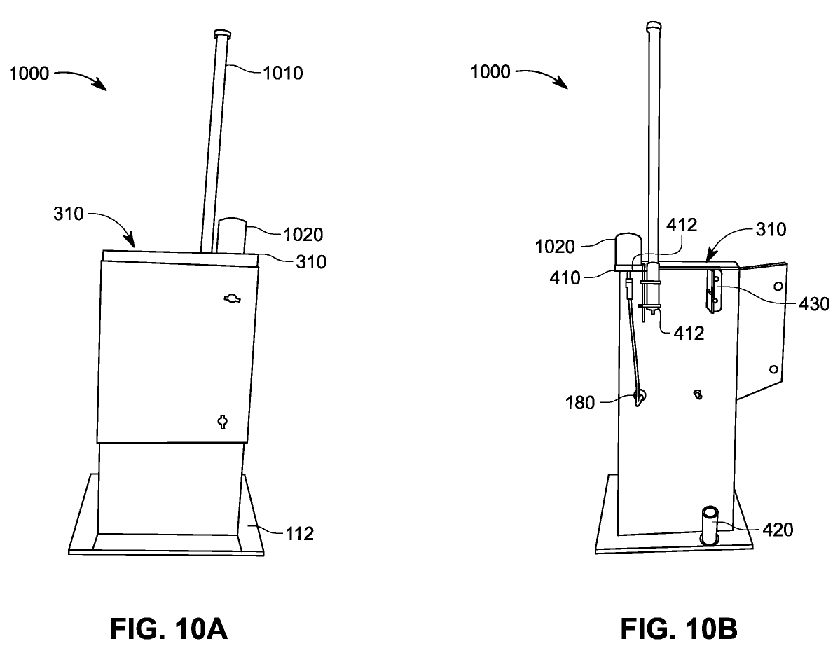

FIG. 9A illustrates a front view of the first mount 140. As discussed herein, the first mount 140 can be configured to secure the AMI device. The first mount 140 can include the apertures 142 configured to secure the AMI device. That is, the apertures 142 can be configured to align with mounting points of the AMI device to allow the AMI device to be mounted within the enclosure (e.g., the enclosure 110 and the enclosure 310). The first mount 140 can be in the form of a bracket, the bracket integral with an interior wall of the enclosure, and the bracket having the apertures 142. In some embodiments, the apertures 142 can be substantially circular. In other embodiments, as shown in FIG. 9A, an aperture of the apertures 142 can have a substantially circular portion and an elongated portion which, as understood by those skilled in the art, can allow a mounting point of the AMI device to be inserted into the substantially circular portion, then translated and secured into the elongated portion. In this way, the AMI device can include mounting points configured to interface with the aperture including the substantially circular portion and the elongated portion. Further, the apertures 142 can each include the substantially circular portion and the elongated portion, and be arranged to align with the mounting points of the AMI device.

FIG. 9B illustrates a side view of the first mount 140 including an aperture 144. The aperture 144 can be disposed on a side portion of the first mount 140, the side portion extending from portions integral with the interior wall of the enclosure and a portion of the first mount 140 including the apertures 142. In some embodiments, the aperture 144 can provide a pathway for one or more electrical connections between the AMI device and other electrical components of the system (e.g., the system 100 and the system 300). For example, a conduit connecting the AMI device to the battery, the solar power assembly, the solar controller unit, an external energy source (e.g., a pad transformer), or any combination thereof can be secured within the aperture 144. That is, the first mount 140 can enable a quick and secure mounting of the AMI device, and the aperture 144 can support ease of connections of any and all required cables/electrical connections, as understood herein.

FIG. 9C illustrates a top view of the first mount 140 including mounting plates 146. The mounting plates 146 can be configured to be integral with the interior wall of the enclosure. In this way, the mounting plates 146 can secure the first mount 140 to the interior (e.g., the interior 130) of the enclosure. As shown, the first mount 140 can be in the form of a bracket including a plurality of plates. The plurality of plates, in some embodiments, can include the mounting plates 146, a primary plate, and side plates disposed between the primary plate and the mounting plates 146. The primary plate can include the portion of the first mount 140 including the apertures 142, and the side plates can include the side portion including the aperture 144. In this way, the portion of the first mount including the apertures 142 can extend outwardly from the interior wall of the enclosure that the mounting plates 146 are integral with; the mounting plates 146 securing the first mount 140 to the interior wall of the enclosure. As discussed herein, the mounting plates 146 can be integral with the interior wall of the enclosure via welding, or any similar form of permanent joining understood in the art. In other embodiments, the mounting plates 146 can be fastened to the interior wall of the enclosure.

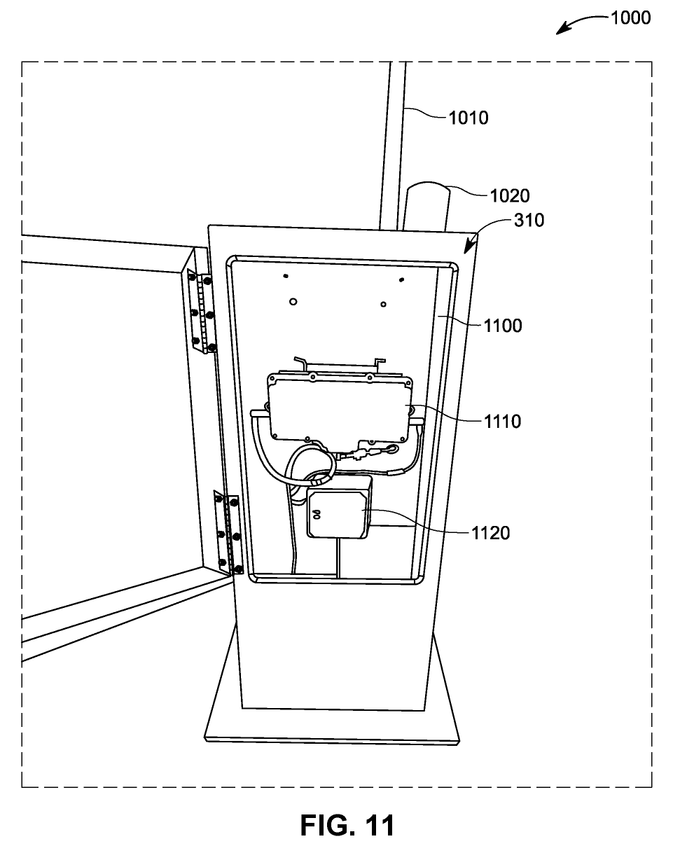

FIGS. 10A and 10B illustrate a system 1000 including a first antenna 1010 and a second antenna 1020. The system 1000 can include any embodiments of the system 100 and the system 300 discussed herein, in that the system 1000 can include the enclosure 310 (which can include any embodiments of the enclosure 110). The first antenna 1010 and the second antenna 1020 can be configured to be mounted to the enclosure 310 via the antenna mount assembly 410. As discussed herein, the antenna mount assembly 410 can include the first antenna mount 412 and the second antenna mount 414, such that the first antenna 1010 can be secured to the first antenna mount 412 and the second antenna 1020 can be secured the second antenna mount 414. That is, the first antenna 1010 can be securable to the first antenna mount 412 via the first configuration of the first antenna mount 412, and the second antenna 1020 can be securable to the second antenna mount 414 via the second configuration of the second antenna mount 414. Accordingly, the first antenna 1010 can be characterized by a first antenna type, and the second antenna 1020 can be characterized by a second antenna type, as will be discussed in greater detail herein. In this way, the antenna mount assembly 410 can be configured to secure multiple antennas to the exterior of the enclosure 310.

As shown, the first antenna 1010 can include a portion extending substantially vertically from a top portion of the enclosure 310 and a portion secured within a mounting mechanism of the first antenna 1010. Further, the mounting mechanism can be securably fastened to the first antenna mount 412 of the antenna mount assembly 410 via a plurality of bolts of the mounting mechanism aligning with and extending through corresponding apertures of the first antenna mount 412. The second antenna 1020 can be similarly securably fastened to an aperture of the second antenna mount 414. Additionally, the second antenna 1020 can include a conduit extending through the aperture of the second antenna mount 414 and an aperture of the one or more apertures 180. In this way, the second antenna 1020 can be electrically connected to interior components of the enclosure 310, such as the AMI device. As discussed herein, the aperture of the one or more apertures 180 can include a water-tight grommet to prevent intrusion of water into the enclosure through the aperture. As shown, the conduit from the second antenna 1020 can be configured to pass through the water-tight grommet of the aperture of the one or more apertures 180 to ensure any electrical connection between the second antenna 1020 and interior components of the enclosure 310 does not compromise water intrusion prevention of the enclosure 310.

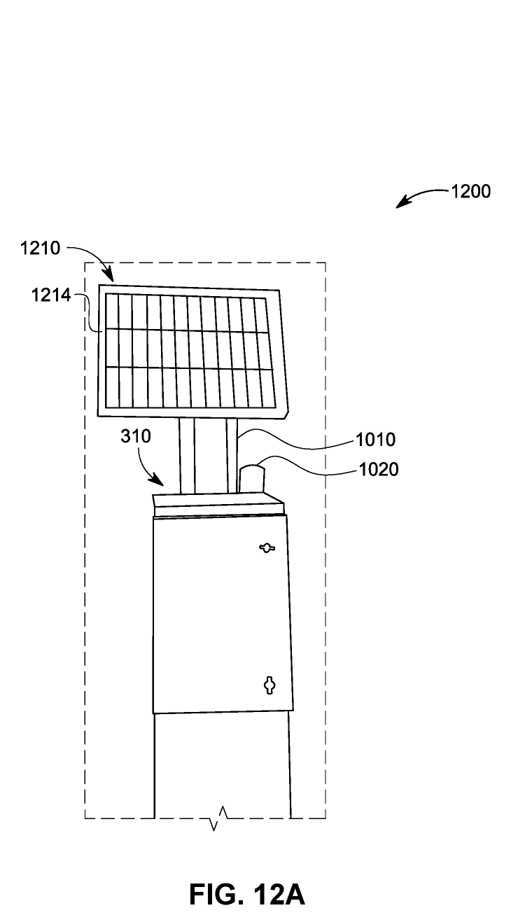

FIG. 11 illustrates an interior 1100 of the enclosure 310 of the system 1000 including an AMI device 1110 and a battery 1120. The AMI device 1110 can include any embodiments of the AMI devices discussed herein, and the battery 1120 can include any embodiments of batteries discussed herein. As shown, the AMI device 1110 can be secured to the first mount 140 within the interior 1100 of the enclosure 310, and the battery 1120 can be secured to the battery mount 160 within the interior 1100 of the enclosure 310. The battery 1120 can be electrically connected to the AMI device 1110, such that the battery 1120 can be configured to provide power to the AMI device 1110. As discussed herein, the AMI device 1110 can be electrically connected to the first antenna 1010 and/or the second antenna 1020 via the aperture of the one or more apertures 180.

In some embodiments, the system 1000 can be an AC power solution, in that the system 1000 can be configured to operate using alternating current (AC) electrical power provided by an external source. As will be discussed in greater detail herein, the external source of power for the system 1000 can include a pad mount transformer, in that the system 1000 can include a conduit electrically connecting the AMI device 1110 disposed within the enclosure 310 to the pad mount transformer. Accordingly, the battery 1120 can be a backup battery, in that the battery 1120 can be configured to power the AMI device 1110 in the event of a loss of power from the external source.

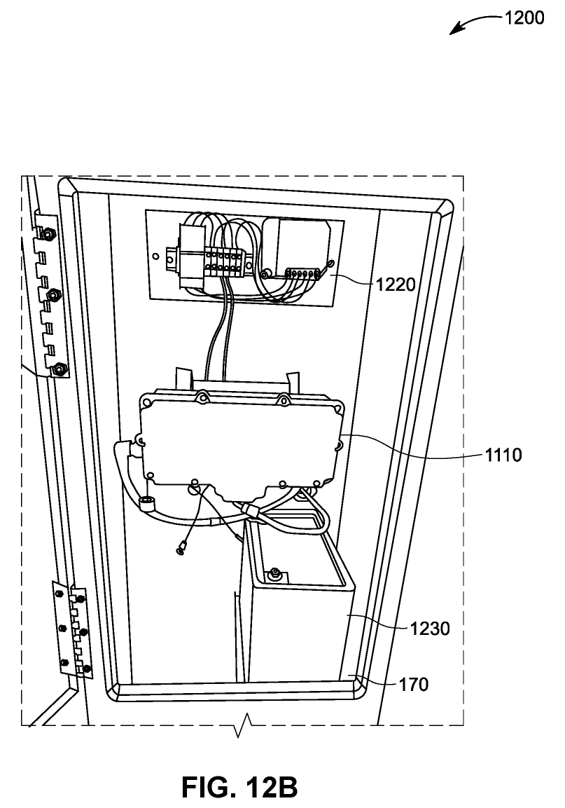

FIGS. 12A and 12B illustrate a system 1200 for housing AMI equipment configured to operate, at least partially, via solar power. As shown in FIG. 12A, the system 1200 can include the enclosure 310, the first antenna 1010, the second antenna 1020, and a solar power assembly 1210. The system 1200 can include any embodiments of the system 100, the system 300, and the system 1000 discussed herein. Additionally, the solar power assembly 1210 can include any embodiments of the solar power assembly discussed herein, in that the solar power assembly 1210 can include a solar mast 1212 and a solar panel 1214. As can be appreciated, the solar mast 1212 can include any embodiments of the solar mast 700 discussed herein. That is, although not shown, the solar mast 1212 can be configured to be secured to the enclosure 310 via the solar mount assembly including at least the post 420 and the solar mast mount 430. The solar mast 1212 can extend vertically from the post 420 and past a top side of the enclosure 310 so that the solar panel 1214 can be disposed above the top side of the enclosure 310. In some embodiments, the solar panel 1214 can be coupled to the solar mast 1212 so as to be rotatable, such that the solar panel 1214 can be configured to be pivoted about a centerline axis of the solar mast 1212. In this way, the solar panel 1214 can be adjusted, as understood in the art, to face directions of oncoming sunlight, so as to increase an amount of energy generated via the solar power assembly. In some embodiments, the solar mast 1212 can be secured to the solar mount assembly so as to be pivotable about its centerline axis. In this way, the solar panel 1214 can be azimuthally adjustable via rotating the solar mast 1212. As can be appreciated, the solar panel 1214 can be azimuthally adjustable about at least a second axis of rotation, as understood for similar coupling mechanisms for solar panels in the art.

As shown in FIG. 12B, the system 1200 can include a solar controller unit 1220, the AMI device 1110, and a battery 1230. The solar controller unit 1220 can include any embodiments of the solar controller unit discussed herein, in that the solar controller unit 1220 can be electrically connected to the solar power assembly and can be secured within the interior of the enclosure 310 via the second mount 150 or the second mount 350. That is, the solar controller unit 1220 can include a mounting mechanism including one or more mounting points configured to align with the plurality of apertures 152, the plurality of protrusions 154, and/or the plurality of protrusions 204. The solar controller unit 1220 can be configured to monitor and operate the solar power assembly 1210. That is, the solar controller unit 1220 can be electrically connected to the solar panel 1214 and can regulate voltage and current, prevent overcharging, prevent over-discharging, provide temperature control, provide load control, and similar functions for the solar panel 1214.

The battery 1230 can be housed within the enclosure 310 via the shelf 170. That is, the battery 1230 can be configured to rest on the shelf 170 disposed within the enclosure 310. The battery 1230 can include any embodiments of the battery 1120 and the battery discussed herein, in that the battery 1230 can be electrically connected to and configured to provide power to the AMI device 1110. Further, in some embodiments, the battery 1230 can act as a backup power source, configured to discharge if there is a loss of power from a primary source of power for the AMI device 1110. In some embodiments, the battery 1230 can be electrically connected to the solar power assembly 1210, such that the solar power assembly 1210 can charge the battery 1230. In other embodiments, the battery 1230 can act as a backup power source for the solar power assembly 1210. In this way, the system 1200 can be configured to operate solely off of solar power from the solar power assembly 1210.

As discussed for the system 1000, the primary source of power for the AMI device 1110 can be an external source of power, such as a pad mount transformer. In other embodiments, the primary source of power can be solar, in that the solar power assembly 1210 can be configured to power the AMI device 1110. That is, the solar power assembly 1210 can act as the primary source of power for the system 1000, and the battery 1230 can be a solar backup battery. Accordingly, the battery 1230 can be configured to discharge stored power to the AMI device 1110 during periods of low charge for the solar power assembly 1210, such as inclement weather, overcast conditions, etc. In this way, the system 1200 can be configured to operate solely off of solar power from the solar power assembly 1210 and thus in some embodiments need not be electrically connected to a pad mount transformer, or other external power source. As will be discussed in greater detail herein, in other embodiments the system 1200 can be configured to be powered from multiple sources, and switch between power sources based on power needs of the system 1200.

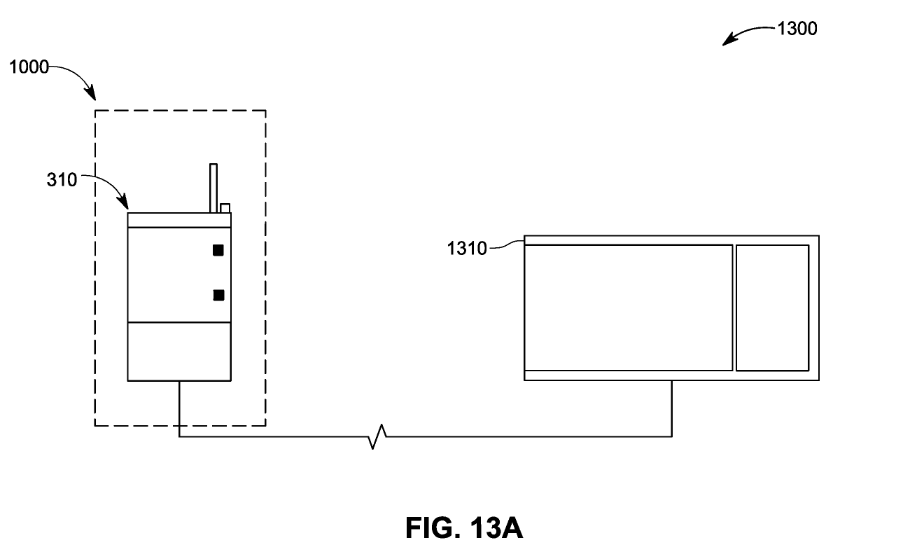

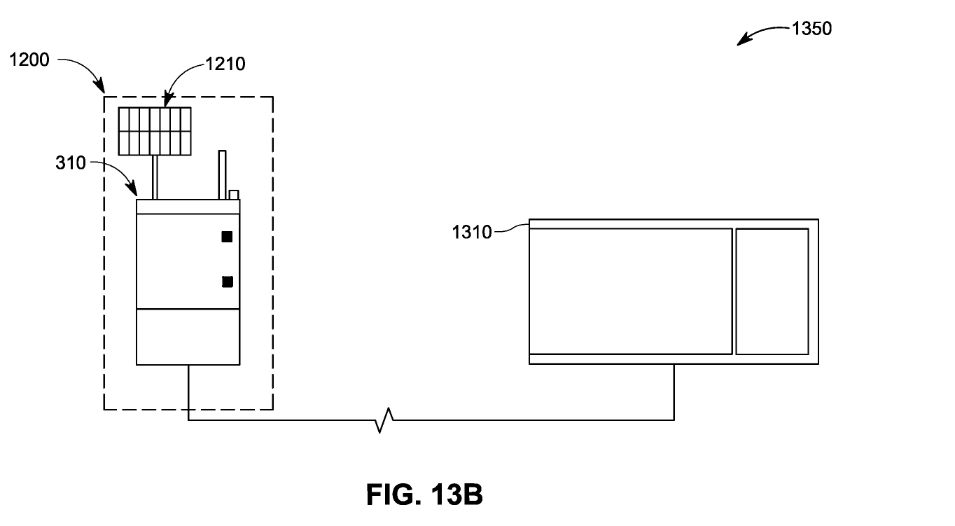

FIG. 13A illustrates a system 1300 including the system 1000 and pad mount transformer 1310. As shown, the system 1200 can be electrically connected to the pad mount transformer 1310, such that the pad mount transformer 1310 can be able to provide power to the system 1000. In some embodiments, the system 1000 can be electrically connected to the pad mount transformer 1310 via a conduit that is disposed, at least partially, below a ground line (e.g., the ground line 320). The conduit can include one or more cables electrically connecting the system 1000 to the pad mount transformer 1310. For example, the conduit can be configured to connect the AMI device 1110 of the system 1000 to the pad mount transformer 1310. As can be appreciated, at least part of the enclosure 310 of the system 1000 can be installed below the ground line, such that the conduit can run underground from the system 1000 to the pad mount transformer 1310. In this way, the pad mount transformer 1310 can act as the primary source of power for the system 1000.

In some embodiments, the system 1300 can be characterized as an AC power system. Stated otherwise, the system 1300, and specifically the AMI device 1110 of the system 1000, can be configured to be powered via an AC power source, such as the pad mount transformer 1310.

Similarly, FIG. 13B illustrates a system 1350 including the system 1200 and pad mount transformer 1310. As shown, the system 1200 can be electrically connected to the pad mount transformer 1310, such that the pad mount transformer 1310 can be able to provide power to the system 1200. In some embodiments, the system 1200 can be electrically connected to the pad mount transformer 1310 via a conduit that is disposed, at least partially, below the ground line 320. The conduit can include one or more cables electrically connecting the system 1200 to the pad mount transformer 1310. For example, the conduit can be configured to connect the AMI device 1110 of the system 1000 to the pad mount transformer 1310. As can be appreciated, at least part of the enclosure 310 of the system 1200 can be installed below the ground line, such that the conduit can run underground from the system 1200 to the pad mount transformer 1310. As discussed herein, the system 1200 can be powered via the solar power assembly 1210, in that the AMI device 1110 can be powered via the solar power assembly 1210. Additionally, the system 1200 can be powered via the pad mount transformer 1310 enabling the system 1200 to have at least two sources of power. The system 1200 can be configured to be powered by both the solar power assembly 1210 and the pad mount transformer 1310 simultaneously, or, in some embodiments, be configured to swap between the solar power assembly 1210 and the pad mount transformer 1310 as a primary source of power. In this way, the system 1350 can be characterized as an AC power and a solar power system, in that the system 1200 of the system 1350 can be configured to operate using AC power from the pad mount transformer 1310 and solar power from the solar power assembly 1210.

Although not shown, in other embodiments the system 1200 can operate independently of a pad mount transformer (e.g., the pad mount transformer 1300). That is, the system 1200 can be configured to power the AMI device 1110 solely via the solar power assembly 1210 and optionally the battery 1230. In this way, the system 1200 can operate as a stand-alone system, powering internal components via solar power from the solar power assembly 1210 and activating the battery 1230 in situations where solar power is temporarily low or unavailable.

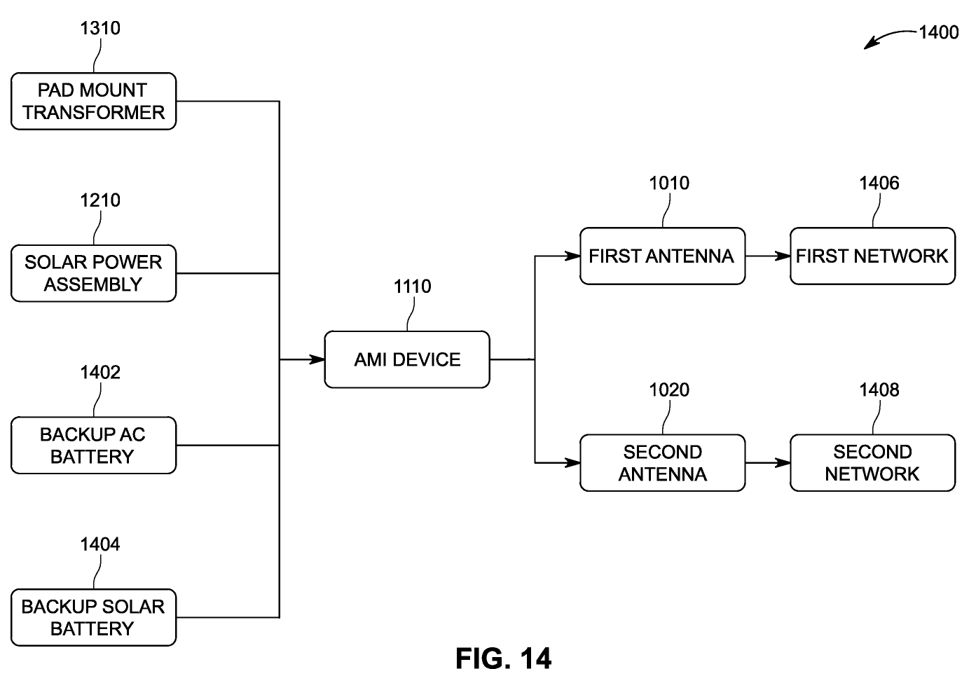

FIG. 14 illustrates a block diagram of a system 1400 including the AMI device 1110. The AMI device 1110 can include any embodiments of AMI devices discussed herein, in that the AMI device can include equipment for facilitating advanced metering processes understood in the art. The system 1400 can include the pad mount transformer 1310 and the solar power assembly 1210 electrically connected to the AMI device 1110. That is, in some embodiments, the AMI device 1110 can be configured to be powered by the pad mount transformer 1310, the solar power assembly 1210, or both. In this way, the system 1400 can be characterized as an AC power solution and a solar power solution. The system 1400 can include a backup AC battery 1402 and a backup solar battery 1404. The backup AC battery 1402 can include any embodiments of the battery 1120 discussed herein, and the backup solar battery can include any embodiments of the battery 1230 discussed herein. That is, the backup AC battery 1402 can be configured to be secured within the enclosure 310 via the battery mount 360, and the backup solar battery 1404 can be configured to be housed within the enclosure 310 via the shelf 170. As can be appreciated, in other embodiments the backup solar battery 1404 can be secured to the battery mount 360, and the backup AC battery 1402 can be housed on the shelf 170. The backup AC battery 1402 can be an auxiliary power for the pad mount transformer 1310, in that the backup AC battery 1402 can be electrically connected to the AMI device 1110 and provide AC power to the AMI device. Similarly, the backup solar battery 1404 can be an auxiliary power to the solar power assembly 1210, in that the backup solar battery 1404 can be electrically co0nnected to the AMI device 1110 and provide DC power to the AMI device 1110.

The AMI device 1110 can be electrically connected to the first antenna 1010, and the first antenna 1010 can be configured to communicate with a first network 1406. That is, the AMI device 1110 can include a radio and/or radio equipment, such that the AMI device 1110 can be configured to transmit and receive radio communications via the first antenna 1010. The first network 1406 can include a local network, an external network, a cellular network, an RF network, or any similar network understood by those skilled in the art for communicating advanced metering information. In this way, the AMI device 1110 can be configured to generate wireless communication indicative of advanced metering information and transmit said wireless communication to the first network 1406 via the first antenna 1010.

Similarly, the AMI device 1110 can be electrically connected to the second antenna 1020, and the second antenna 1020 can be configured to communicate with a second network 1408. That is, the AMI device 1110 can be configured to transmit and receive wireless communications, including radio communication, via the second antenna 1020. The second network 1408 can include a local network, and external network, a cellular network, an RF network, or any similar network understood by those skilled in the art for communicating advanced metering information. In this way, the AMI device 1110 can be configured to generate wireless communication indicative of advanced metering information and transmit said wireless communication to the second network 1408 via the second antenna 1020.

In some embodiments, the first network 1406 and the second network 1408 can be different networks, in that the AMI device 1110 can be configured to communicate with multiple networks via the first antenna 1010 and the second antenna 1020. As a non-limiting example, the first network 1406 can include a cellular network, and the second network 1408 can include an RF network. Accordingly, in some embodiments, the first antenna 1010 can be a cellular antenna, and the second antenna 1020 can be an RF antenna. Stated otherwise, the first antenna 1010 can have a first antenna type, and the second antenna 1020 can have a second antenna type, such that antenna type can correspond to a network type associated with the antenna type. In other embodiments, the first network 1406 and the second network 1408 can include the same network. In this way, the second antenna 1020 can act as a backup antenna configured to ensure continuous network connectivity in the event of a failure of the first antenna 1010.

The disclosed technology can be further understood according to the following clauses:

Clause 1: A system for housing advanced metering infrastructure (AMI) equipment, comprising: an enclosure; a door hingedly connected to the enclosure; and a first mount configured to secure an AMI device within an interior of the enclosure.

Clause 2: The system of Clause 1, further comprising: a second mount configured to secure a solar controller unit within the interior; and a solar mount assembly configured to secure a solar power assembly to the enclosure.

Clause 3: The system of Clause 2, wherein the solar power assembly is configured to power the AMI device, the solar mount assembly comprising: a cylinder portion positioned proximate a bottom side of the enclosure, the cylinder portion extending vertically towards an upper side of the enclosure, the cylinder portion configured to receive a solar mast coupled to a solar panel; and one or more solar mast mounts configured to secure, at one or more points along a length of the solar mast, the solar mast to the enclosure.

Clause 4: The system of Clause 2, wherein the second mount comprises a plurality of apertures and a plurality of protrusions positioned on the enclosure to align with corresponding mounting points of the solar controller unit.

Clause 5: The system of Clause 1, wherein the enclosure comprises an aluminum material, and wherein the enclosure further comprises an opening, the door configured to cover the opening when in a closed position, the opening comprising an outer flange extending away from a center of the opening and configured to inhibit water from intruding into an interior of the enclosure.

Clause 6: The system of Clause 1, wherein the interior of the enclosure, when the enclosure is installed, is configured to be disposed, at least partially, below a ground line.

Clause 7: The system of Clause 1, further comprising: a pad mount transformer comprising a power source; and a conduit connecting the pad mount transformer and the enclosure, the power source electrically connected to the AMI device via the conduit.

Clause 8: The system of Clause 1, wherein the enclosure further comprises one or more pre-drilled apertures configured to facilitate electrical connection between components disposed on the interior of the enclosure and components disposed on an exterior of the enclosure.

Clause 9: The system of Clause 8, wherein an aperture of the one or more pre-drilled apertures comprises a water-tight grommet.

Clause 10: The system of Clause 1, wherein the first mount comprises a bracket integral with an interior wall of the enclosure.

Clause 11: The system of Clause 1, wherein the enclosure further comprises one or more antenna mounts disposed on an exterior of the enclosure configured to secure one or more antennas, the AMI device further configured to transmit and receive wireless communication via the one or more antennas.

Clause 12: The system of Clause 11, wherein the one or more antenna mounts comprise: a first antenna mount having a first configuration for attaching a first antenna type to the exterior of the enclosure; and a second antenna mount having a second configuration for attaching a second antenna type to the exterior of the enclosure.

Clause 13: The system of Clause 1, further comprising a battery mount disposed within an interior of the enclosure, the battery mount configured to secure a battery.

Clause 14: The system of Clause 1, further comprising a shelf disposed on a side wall of the enclosure, the shelf configured to support a battery.

Clause 15: A system for housing advanced metering infrastructure (AMI) equipment, comprising: an enclosure; a door hingedly connected to the enclosure; a first mount configured to secure an AMI device within an interior of the enclosure; a second mount configured to secure a solar controller unit within the interior of the enclosure; a solar mount assembly configured to secure a solar power assembly to an exterior of the enclosure; and a battery mount configured to secure a battery within the interior of the enclosure.

Clause 16: The system of Clause 15, wherein the first mount comprises a bracket integral with an interior wall of the enclosure, the bracket comprising a plurality of apertures positioned to align with corresponding mounting points of the AMI device.

Clause 17: The system of Clause 15, wherein the enclosure comprises a second mount, the second mount comprising a plurality of apertures and a plurality of protrusions configured to align with corresponding mounting points of the solar controller unit.

Clause 18: The system of Clause 17, wherein the plurality of apertures extend through a side wall of the enclosure.

Clause 19: The system of Clause 15, wherein the solar power assembly is configured to power the AMI device, the solar mount assembly comprising: a cylinder portion positioned proximate a bottom side of the enclosure, the cylinder portion extending vertically towards an upper side of the enclosure, the cylinder portion configured to receive a solar mast coupled to a solar panel; and one or more solar mast mounts configured to secure, at one or more points along a length of the solar mast, the solar mast to the enclosure.

Clause 20: The system of Clause 15, wherein the battery mount comprises a plurality of studs disposed on an interior wall of the enclosure and positioned to align with mounting points of the battery.

While the present disclosure has been described in connection with a plurality of exemplary aspects, as illustrated in the various figures and discussed above, it is understood that other similar aspects can be used, or modifications and additions can be made to the described subject matter for performing the same function of the present disclosure without deviating therefrom. In this disclosure, systems and compositions were described according to aspects of the presently disclosed subject matter. But other equivalent systems or compositions to these described aspects are also contemplated by the teachings herein. Therefore, the present disclosure should not be limited to any single aspect, but rather construed in breadth and scope in accordance with the appended claims.

What is claimed is:

1. A system for housing advanced metering infrastructure (AMI) equipment, comprising:
an enclosure;
a door hingedly connected to the enclosure; and
a first mount configured to secure an AMI device within an interior of the enclosure.

2. The system of claim 1, further comprising:
a second mount configured to secure a solar controller unit within the interior; and
a solar mount assembly configured to secure a solar power assembly to the enclosure.

3. The system of claim 2, wherein the solar power assembly is configured to power the AMI device, the solar mount assembly comprising:
a cylinder portion positioned proximate a bottom side of the enclosure, the cylinder portion extending vertically towards an upper side of the enclosure, the cylinder portion configured to receive a solar mast coupled to a solar panel; and
one or more solar mast mounts configured to secure, at one or more points along a length of the solar mast, the solar mast to the enclosure.

4. The system of claim 2, wherein the second mount comprises a plurality of apertures and a plurality of protrusions positioned on the enclosure to align with corresponding mounting points of the solar controller unit.

5. The system of claim 1, wherein the enclosure comprises an aluminum material, and wherein the enclosure further comprises an opening, the door configured to cover the opening when in a closed position, the opening comprising an outer flange extending away from a center of the opening and configured to inhibit water from intruding into an interior of the enclosure.

6. The system of claim 1, wherein the interior of the enclosure, when the enclosure is installed, is configured to be disposed, at least partially, below a ground line.

7. The system of claim 1, further comprising:
a pad mount transformer comprising a power source; and
a conduit connecting the pad mount transformer and the enclosure, the power source electrically connected to the AMI device via the conduit.

8. The system of claim 1, wherein the enclosure further comprises one or more pre-drilled apertures configured to facilitate electrical connection between components disposed on the interior of the enclosure and components disposed on an exterior of the enclosure.

9. The system of claim 8, wherein an aperture of the one or more pre-drilled apertures comprises a water-tight grommet.

10. The system of claim 1, wherein the first mount comprises a bracket integral with an interior wall of the enclosure.

11. The system of claim 1, wherein the enclosure further comprises one or more antenna mounts disposed on an exterior of the enclosure configured to secure one or more antennas, the AMI device further configured to transmit and receive wireless communication via the one or more antennas.

12. The system of claim 11, wherein the one or more antenna mounts comprise:
a first antenna mount having a first configuration for attaching a first antenna type to the exterior of the enclosure; and
a second antenna mount having a second configuration for attaching a second antenna type to the exterior of the enclosure.

13. The system of claim 1, further comprising a battery mount disposed within an interior of the enclosure, the battery mount configured to secure a battery.

14. The system of claim 1, further comprising a shelf disposed on a side wall of the enclosure, the shelf configured to support a battery.

15. A system for housing advanced metering infrastructure (AMI) equipment, comprising:
an enclosure;
a door hingedly connected to the enclosure;
a first mount configured to secure an AMI device within an interior of the enclosure;
a second mount configured to secure a solar controller unit within the interior of the enclosure;
a solar mount assembly configured to secure a solar power assembly to an exterior of the enclosure; and
a battery mount configured to secure a battery within the interior of the enclosure.

16. The system of claim 15, wherein the first mount comprises a bracket integral with an interior wall of the enclosure, the bracket comprising a plurality of apertures positioned to align with corresponding mounting points of the AMI device.

17. The system of claim 15, wherein the enclosure comprises a second mount, the second mount comprising a plurality of apertures and a plurality of protrusions configured to align with corresponding mounting points of the solar controller unit.

18. The system of claim 17, wherein the plurality of apertures extend through a side wall of the enclosure.

19. The system of claim 15, wherein the solar power assembly is configured to power the AMI device, the solar mount assembly comprising:
a cylinder portion positioned proximate a bottom side of the enclosure, the cylinder portion extending vertically towards an upper side of the enclosure, the cylinder portion configured to receive a solar mast coupled to a solar panel; and
one or more solar mast mounts configured to secure, at one or more points along a length of the solar mast, the solar mast to the enclosure.

20. The system of claim 15, wherein the battery mount comprises a plurality of studs disposed on an interior wall of the enclosure and positioned to align with mounting points of the battery.
